(19) United States
(12) Patent Application Publication
(10) Pub. No.: US 2019/0075775 A1
(43) Pub. Date: Mar. 14, 2019

(54) ONE WAY Mosquito trap

(71) Applicant: Dean DeVolpi, Las Vegas, NV (US)

(72) Inventor: Dean DeVolpi, Las Vegas, NV (US)

(21) Appl. No.: 15/700,325

(22) Filed: Sep. 11, 2017

(51) Int. Cl. A01M 1/10; A01M 1/02

(52) U.S. Cl. CPC A01M 1/106; A01M 1/02

(57) ABSTRACT

Ultra low cost and low maintenance one-way mosquito trap that is easy to enter with standard lures like water alone but has a non-intuitive to the mosquito method to stop them from finding the reverse path out. Other benefits are even if neglected never becomes a part of the problem, one embodiment does not require power. No stick tapes needed, no messy oils, no pesticides or hazardous materials needed. Can use a recycled soda bottle to be environmentally friendly. A diseased carrying mosquito enters and cannot escape stopping the spread of disease. A true one-way mosquito trap.

### FIELD OF THE INVENTION

The present invention relates to a mosquito trap that a mosquito enters and then cannot exit.

### DESCRIPTION OF THE PRIOR ART

It is therefore an object of this invention to provide a trap for flying mosquitos which will overcome or at least greatly minimize the disadvantages of cited art.

This innovation, a lethal mosquito trap, is in the class of low cost, no significant maintenance, easy set-up, ecologically and environmentally friendly, low purchase risk, does not require power, no consumables like CO₂, no sticky tapes, no messy oils, and can be used year after year with an end of life 10 or more years.

Specifically, for the mosquito, this novel trap methodology can be used in the two major hunting cycles of the mosquito, one to find food to live or to produce eggs, or the other cycle a suitable place to lay eggs. This novel one-way trap has been tested in natural situations and has proved this methodology works. It does not allow the mosquito to escape, and not only captures the mosquito, the mosquito dies as well as its offspring. We have seen more cases of 100% effective kill rate in not being able to escape in our present embodiment in our testing than other. What this means in the real world is if a vector disease carrying mosquito enters we stop the disease spread immediately to rates of 100%. Other art the mosquito is capable of passing vector diseases it lays eggs and goes for another blood infusion to lay eggs again and again. She can do this every couple days. Hence, infecting many people in each feeding. She enters one of our traps and the cycle ends there.

There are many traps dating back over 100-150 years ago that were patented for flies and cock roaches and flies that are one-way traps by simple intuitive hole the bug cannot get out. Some of these flies and cock roach traps are also too difficult for a mosquito to enter. As a result, this has eluded us with mosquitoes because they apparently are capable of using enhanced and or multiple sensory inputs that allow them to be escape artists like no other flying insect, yet they need a simplified entryway that is intuitive for them. It is our belief that their numerous eyes with different wavelength responses that we humans do not see and their power of the ability to “smell” track densities of molecules has provided them with the ability to elude mankind's trap endeavors with more simplistic static traps. For instance, mosquito's smelling systems are so evolved that it can determine which water source is more ideal for laying eggs when several are offered in experiments it has been found. There are several traps that have independent double entry that would still be intuitive to back tracking by a mosquito because of its highly sophisticated sensory input devices. To date these have not been shown to have an impact. Our one-way technology has effectively found how to prevent the mosquito from escaping statically without messy sticky things, and at a very high rate in most tests hitting 100%.

This trap methodology fools the mosquito's natural senses into using the intuitive actions for escape via a large landing area (which is the dead end) vs the non-intuitive exit ones that got the mosquito into the trap. There is as another benefit, not only is it effective, but it resolved several outstanding human factor issues that other traps on the market have not overcome to get wider acceptance.

One major human factor this trap overcomes is the lack of maintenance or supervision to operate correctly. These easy to set up, just add water. Another barrier to entry, personal benefit is for required cost. The low cost is inherent in this novel design, it has been suggested the optimum number of ovitraps is from 3-6 per household and more for larger home sites so a ultra-low price we can over minimizes this. Another human factor of ecological morals reinforces the decision to use this ecologically and environmentally friendly product (no chemicals, poisons, can be made from recycled plastic, and can be recycled). The human factor of motivation, at this low cost, is also supported by the increasing effects of negative consequences resulting from “no action”. Using recycled bottles, a low-cost screen entryway element/trap part, and plain water addresses the concerns of prior resistance. Several research publications have noted to be effective ovitraps require at least 3-6 traps per home. With this trap's ultra-low cost this is not a human factor barrier.

Another huge human factor barrier overcome is not having to handle poisons, larvicides, biological agents, change sticky tapes, gauzes, or clean oils is overcome by our trap. Having to maintain 1 and even 6 had been a human factors barrier; people just do not like having maintenance cycles and remembering where all the traps may be. Ours requires minimal interaction. Another major concern for human factors is the real fear of neglect, these can never become a source because of neglect of the problem. Some ovitraps if forgotten can be huge breeding sites if forgotten. With 6 traps at various locations remembering where all are can be an issue too for humans. Not having to worry about maintenance when one leaves on vacation. Many of the most critical human factor issues, including having to do with cost, continual maintenance, or changing out consumables contributing to the acceptance of this product, have been addressed successfully.

This lethal mosquito trap has an intuitive entryway that allows the mosquito to seek and access the water or other lures it desires. Water alone as a lure is intuitive to track because it proven with other ovitraps for 60 years plus that water is an acceptable lure for mosquitos to seek to lay their eggs. This is the survival of the species and to date man has not stopped it. This lethal mosquito trap prevents the mosquito from exiting because it has a non-intuitive feature for exiting. The mosquito cannot use reason, its multiple senses, nor logic, nor intuition, to exit this trap. Some bug traps have put obstacles like hairs, tissue that would block obvious entry and the mosquito is very frail vs a cock roach or fly.

The screen, mesh or perforations are too small for the mosquito or bug to fit through, and the mosquitos or bugs cannot find the small slit opening between two narrow edges to the 95-100 percent range. We have not found any published data any other lethal ovitrap has on this specific aspect of escape efficiency. In general, we find much literature on testing of net decrease in the area by ovitraps which seems to be the standard measurement. Most ovitraps just stop the eggs from either hatching or if hatched the new offspring from escaping, but the potentially infected mosquito escapes and spreads more disease.

Newer ovitraps have sticky material or oils, we do not have numbers for their efficiency as noted for escape after entry. All ovitraps do decrease the net mosquito count when not neglected, this art is different that it cannot be neglected to be part of the problem. We believe that a new metric should be gauge by escape ratio. The reason is earlier we discussed the goal of preventing the infected vector disease spreading mosquito from escaping because we stop further disease spread right away in addition to reducing the number of mosquito's that will hatch in the future.

U.S. Pat. No. 1,209,993 Oettinger will not allow a mosquito to enter via a as it blocks the path too intensely for a mosquito entry as well as a means for opening to clean it out. Our art gives easy entryway that is intuitive not a limiting entranceway, and we have a ramp to guide to the intuitive exitway. Our art is very simple to make vs Oettinger, we can make ours from one piece of screen material by hand not needing any secondary processes minimizing our costs.

U.S. Pat. No. 2,429,377 Stevens is optimized for flies which have different behavioral characteristics and hardiness characteristics than mosquitos. Stevens does not have the food/lure in the trap itself while it is effective for flies it would not be for mosquitos, so there is no reason for the mosquito to fly upwards as its natural flight is sideways or downward into the trap does not have an intuitive entryway lure and does not have non-intuitive exitway from the lure, there is a direct path to freedom.

U.S. Pat. No. 3,505,757 Hall is optimized for flies which have different behavioral characteristics and hardiness characteristics than mosquitos. Hall does not have the food/lure in the trap itself while it is effective for flies it would not be for mosquitos, so there is no reason for the mosquito to fly upwards as its natural flight is sideways or downward into the trap does not have an intuitive entryway lure and does not have non-intuitive exitway from the lure, there is a direct path to freedom.

U.S. Pat. No. 4,244,135 Harwoods is optimized for flies not mosquitos hence Harwoods teaches us a conical entry with a 360 U shape that is nearly impossible for a mosquito to navigate for entry. The entryway 16 is the natural exit for a mosquito does not have the food/lure in the trap itself while it is effective for flys it would not be for mosquitos, so there is no reason for the mosquito to fly upwards into the trap and does not have an intuitive entryway lure to get into the trap portion and does not have non-intuitive exitway from the lure, there is a direct path to freedom.

### SUMMARY OF THE INVENTION

In one embodiment, we increase our natural lure of the humidity/water vapor (or other lures) in the airflow by using a porous screen-mesh design to increase the water vapor outflow. If this design used a closed cell tube, airflow would be limited, thus making it less effective without adding mechanical means of increasing flow. We also have a means of mechanically increasing the airflow to overcome this to make the trap more attractive.

This trap begins with a mosquito flying into an entryway that has generous landing platform that is adjacent to, or in proximity to, a gradually reducing opening upon entry. The mosquito after landing crawls in moving to the reduced sized exit-way that is a intuitive exit coming from the outside. As it arrives to the end it then crawls down or in the case of a mosquito it resumes flying finally entering a containment area of the tripping vessel. After leaping off this reduced exit-way surface that present a compatible environment it is lured to. Those same exit-way surfaces can also be sharp edges or jagged edges from a reverse direction or an existing perspective. This reduced sized exitway is non-intuitive to exit/escape when viewed from the interior of the trapping vessel to the mosquito or bug. The landing area opposite the ramp is intuitive to land on though, which leads to a dead end from the inside.

The mosquito cannot fly or crawl back out of the trap readily intuitively. Once a mosquito enters and accesses the lure like water in the bottom reservoir in an effort lays eggs, its instincts after laying the eggs will tell it to move and it will try to exit to repeat the cycle. The mosquito has many eyes and chemical tracing “nose” antennae and is very capable of finding an exit-way even in clear containers. The non-intuitive features designed into exiting this lethal mosquito trap make it the effective trap, with no intuitive exit from our non-intuitive reduced sized exit-way, for mosquitos and bugs.

This innovative design places an obstacle to the remarkably proficient escape ability of a mosquito by making it non-intuitive. The mosquito or bug cannot figure out an exit based on instinct or data receive from its sensory organs. This design feature that is unique and important is the extended entryway element. This gradual slope ramp over the long entryway, during a welcoming entry, inversely provides for an impossibly small exitway to be able to fly into directly. This extended entryway element also allows for critical input stimuli (e.g. air, moisture, smells, light) to go through the tube/screen to confuse the mosquito as to where is the specific exit way, whereby the mosquito lands on the sides of the screen/mesh or a landing area to the back vs the exit area of the reduced sized exit-way. It also lands on the sides of the trapping vessel that allows escape lures like light waves to enter the vessel.

When trying to escape the mosquitos land on the mesh screen outer surfaces, except at the very bottom facing downward. Mosquitos do not seem to fly upside down, so their flying their wings prevent them from hitting the sky direction features. Hence in the back we have a ramp that it does not land on and a surface below that is intuitive to land on. And in the back mosquitos will walk around the mesh screen surfaces, and go upside down walking, but they will not land in an upside-down orientation. We take advantage of this in our various embodiments and/or design features as illustrated on several embodiments as described throughout this application. We call this an “exit-way non-intuitive feature”. In this embodiment, it is a landing surface, whereby this landing surface intuitive feature is where the mosquito follows the natural walkway which is towards the entryway that is a dead end.

The mosquito lands on the landing area below the exit-way actual opening because to land at the reduced exit-way the wings cannot be flapping as it is not large enough. It is non-intuitive to be able to fly directly into this reduced size exit-way from the inside of the containment area. The mosquito now on the walkway inside of bottom side can walk around and it intuitively walks to the direction of the entranceway of the trapping vessel, which is a dead-end. To walk into the reduced size exit-way it requires a walk the opposite direction it would perceive is the intuitive way out. So, the mosquito would have to walk the opposite way around at the very edge of the reduced size exit-way with no or the low sensory cues to go there to exit. Then even in the least probable walking scenarios have the mosquito or insect having to do a 180 degree sharp turn, which while walking this is not-intuitive to the physiology of the mosquito's walking agility. The intuitive is to land on the nearby landing zone that is larger and walk to the apparent closest point of exit that all senses available would route to. This again is a dead end. Eventually, this being in the trapping vessel exhausts the mosquito and will die in the trap in a day or so.

We can add in methods to increase lures, like air pumps, various mixtures of water, chemicals, light clothing etc. We can add in a screen separator from the lures to prevent eggs from being laid that will hatch. In another embodiment, the trap is placed on an existing septic system vent or house drain/waste/vent riser, where the gases emitted create a natural lure or attraction locations. There can be caps and lids for the top bottom or sides for clean out means and associated.

In another embodiment and natural lure location, such as any human living quarters, these traps can be placed on one surface of a vertical window-screen, and in parallel, we have another secondary window-screen (providing the containment of captured mosquitos or bugs). This is using the natural house odors to attract & lure; standard house airflow can be used as the attractant. In this window-screen trap layout, one can also install a second extended entryway element—one-way trap to allow entry to the containment area from the inside of the human's living quarters. This allows any mosquitos or bugs, that may have entered the living quarters via another opening in the home (e.g. door, produce, packaging) to enter the confinement area and similarly become trapped and expire. This also traps and kills mosquitos who may have had its blood meal.

A barrier in the trapping vessel can be made of various materials and not limited by from metal, silicone, plastic, wood, cloth between the entry side and the lure side of the trapping vessel.

This embodiment innovation stops mosquitos and bugs from breeding in a septic or house vent, provides a device for a widow screen installations, or works as a stand-alone trap. This device is a trap for mosquitos and bugs to fly into, become trapped, and perish. They cannot fly out of this trap. The entryway includes an atmosphere that is bounded by a breathable barrier that allows chemical, water, and light of various wavelengths to pass through with minimal resistance yet a mosquito cannot escape. The porosity of the surfaces is large enough to promote desired affects for the mosquito and bugs, but small enough to keep mosquitos and bugs from escaping.

The entryway boundary is a conduit channel to an endpoint that allows passage into a second chamber via crawling. The entryway boundary minimizes or restricts passage in the reverse direction by the combination of features that confuse the senses by tracking methods like airflow, light density, physical size barrier (mosquitos and bugs will not physically fit and search for larger openings), barbs (hairs) that are slightly bendable or more bendable in one direction, or deception of a maze, or deception of a more likely path.

This trap can be static device or active with electrical or mechanical means to accomplish the same goals or to improve effectiveness. Hole sizes and density are variable and can be larger, smaller, or change in size, pitch, or pattern to be non-intuitive. This device can be fabricated from breathable membrane that allows moisture and vapors as well as light waves to enter and exit.

An addition perforated material, like screen, plastic, cloth or other, can be added above the water source to prevent egg laying in the water reservoir. These innovative lethal mosquito traps prevent the egg laying mosquito from escaping which is essential in stopping vector borne diseases like dengue, zika, chikungunya, yellow fever, and malaria. Many ovitraps do not prevent the egg laying mosquito from escaping. This device methodology, non-intuitive trap can be increased in size or shrunk for insects like midges.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above products and methods without departing from the scope of the invention, it is intended that all matter contained in the above description and shown in the accompanying drawings shall be interpreted as illustrative and not in a limiting sense.

### BRIEF DESCRIPTION OF THE DRAWINGS

These and other objects and features of the invention will become more apparent by referring to the drawing, in which:

FIG. 1 is a cross sectional side view of an embodiment of a mosquito trap trapping vessel according to the present invention;

FIG. 2 is a perspective side view of the mosquito trap extended entryway element of FIG. 1.

FIG. 3 is a cross sectional view of another embodiment of a mosquito trap according to the present invention with a non-intuitive feature being a non-linear density ramp.

FIG. 4 is a cross sectional view of another embodiment of a mosquito trap according to the present invention with a non-intuitive feature being an inverse cupping device.

FIG. 5 is a perspective side view of the mosquito trap placement on a home of a mosquito trap to the present invention.

FIG. 6 is a cross sectional view of another embodiment of a mosquito trap according to the present invention as presented on FIG. 5.

FIG. 7 is a front view of another embodiment of a mosquito trap according to the present invention as presented on FIG. 5.

### DETAILED DESCRIPTION

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents, which operate in a similar manner to accomplish a similar purpose.

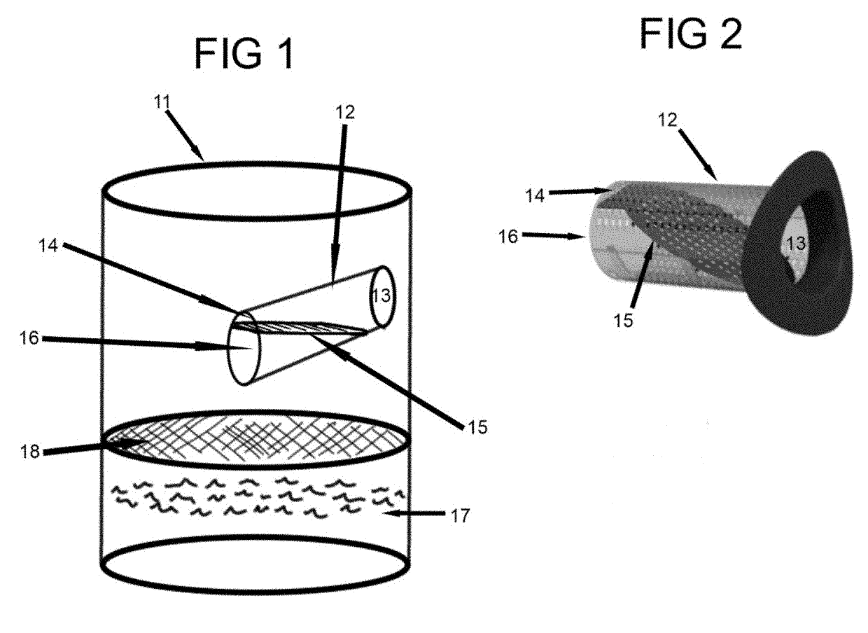

FIG. 1 shows a mosquito trap trapping vessel 11 in accordance with an embodiment of the present invention. This vessel can be made of plastic, metal, wood, glass paper and other materials. The trapping vessel 11 can be a closed unit or can have a cap, bottom or midsection cap, separating part, both bottom and top caps, a pouring spout, a hanging mechanism.

The extended entryway element 12 can be made of plastic, metal, wood, glass, and so on, can be solid and or allow air moisture light to pass or can be screen and same, can also be non-linear density and has several core elements to it, an entryway 13 that allows mosquitos to enter the trap while flying wings in motion.

The mosquito enters entryway 13 has a lure 17 within the trapping vessel 11 that attracts mosquitos. The lure 17 may be of many different types as shown water, from articles of worn clothing like socks, chemicals, CO2, light waves that are found to be attractive to the specific mosquito.

The extended entryway element 12 that can be linear density or non-linear density and has a corresponding reduced size exit-way 14 that is intuitive for the mosquito to then enter the trapping vessel 11 at the entryway 13. The mosquito walks up or onto the ramp 15 that can be linear airflow density or non-linear density. On the back end of the extended entryway element 12 the mosquito exits the reduced size exit-way 14 into the interior of the trapping vessel 11.

The mosquito upon drinking water or laying eggs or whatever it entered for, then begins its exit and tries to exit via the intuitive ways like wall of the trapping vessel 11 or the outside of the extended entryway element 12 and finally trying the back surface of the extended entryway element 12 finally finding the landing area of non-intuitive feature 16. Not being able to land in the reduced size exit-way 14 directly because of the space required for flapping wings making it non-intuitive.

Within the trapping vessel 11 there can be a physical barrier 18 between the extended entryway element 12 and the lure 17 to prevent mosquitos from actually laying the eggs such that they are able to hatch. This physical barrier 18 can be made of screen, mesh, cloth plastic or other materials that allow the lure to penetrate.

FIG. 2 shows an embodiment of the extended entryway element 12 with an entryway 13 and a reduced size exit-way 14 and dead end ramp 15 that is a non-intuitive feature 16. This extended entryway element 12 can be inserted into a trapping vessel 11.

FIG. 3 shows an embodiment of a trapping vessel lithe extended entryway element 12 with an entryway 13 and a dual element reduced size exit-ways 14a and 14b and dual dead end ramp 15a and 15b that is a dual non-intuitive feature 16a and 16b.

FIG. 4 shows an embodiment of a trapping vessel lithe extended entryway element 12 with an entryway 13 and an element reduced size exit-way 14 and a dead end ramp 15 that is a non-intuitive feature 16 that is a inverse cupping device 18 in a cup shape.

FIG. 5 shows a home 19 with an attached trapping vessel 11.

FIG. 6 shows a side view of the trapping vessel 11 is bounded with opposing screens 20a and 20b sides that are perpendicular to said extended entryway element 12 sides bounded by screens 20a and 20b. Plus the extended entryway element 12 with an entryway 13 and a reduced size exit-way 14 and dead end ramp 15 that is a non-intuitive feature 16.

FIG. 7 shows a inside out view of the trapping vessel 11 is bounded with opposing screened side 20 that are perpendicular to said extended entryway element 12 with an entryway 13 and a dual element reduced size exit-ways 14a and 14b and dual dead end ramp 15a and 15b that is a dual non-intuitive feature 16a and 16b.

### CITED PRIOR ART

U.S. Pat. No. 15,378 Hyter
U.S. Pat. No. 15,752 Arnold
U.S. Pat. No. 17,811 Shannon
U.S. Pat. No. 20,091 Riley
U.S. Pat. No. 21,726 Shell
U.S. Pat. No. 25,997 Elwell
U.S. Pat. No. 29,468 Cottingham
U.S. Pat. No. 38,277 Basett
U.S. Pat. No. 61,561 Pardee
U.S. Pat. No. 71,346 Weaver
U.S. Pat. No. 111,936 Horton
U.S. Pat. No. 127,297 Beach
U.S. Pat. No. 128,982 Skeen
U.S. Pat. No. 122,579 Friend
U.S. Pat. No. 138,797 Ernst et al.
U.S. Pat. No. 140,176 Whiting
U.S. Pat. No. 143,423 Rouse
U.S. Pat. No. 145,791 Eicholtz
U.S. Pat. No. 149,918 Clough
U.S. Pat. No. 158,238 Bray
U.S. Pat. No. 161,354 Roe
U.S. Pat. No. 161,814 Nelson
U.S. Pat. No. 166,268 Ferris
U.S. Pat. No. 171,673 Littlefield
U.S. Pat. No. 185,724 Carroll
U.S. Pat. No. 418,233 Sallade
U.S. Pat. No. 404,565 Schuyler
U.S. Pat. No. 455,096 Cohen
U.S. Pat. No. 464,343 Nile
U.S. Pat. No. 550,891 Lawton
U.S. Pat. No. 573,814 Daughtrey er al.
U.S. Pat. No. 601,953 Englebrecht
U.S. Pat. No. 812,761 Meier,
U.S. Pat. No. 862,079 Lenthier
U.S. Pat. No. 882,631 Fuller
U.S. Pat. No. 914,571 Heath
U.S. Pat. No. 920,696 Turner
U.S. Pat. No. 951,763 Malphurs
U.S. Pat. No. 983,977 A Lilge
U.S. Pat. No. 1,005,530 Fritsch
U.S. Pat. No. 1,043,774 Kirkman
U.S. Pat. No. 1,057,867 Meadows
U.S. Pat. No. 1,085,205 Hamilton
U.S. Pat. No. 1,085,388 Overmyer
U.S. Pat. No. 1,102,141 Cooley
U.S. Pat. No. 1,313,837 Schkantz
U.S. Pat. No. 1,139,717 Pipenhagan
U.S. Pat. No. 1,496,135 Schwiening.
U.S. Pat. No. 1,178,076 Jefferis
U.S. Pat. No. 1,569,681 Schenk
U.S. Pat. No. 1,185,935 Pugh
U.S. Pat. No. 1,209,993 Oettinger
U.S. Pat. No. 1,277,354 Arabian
U.S. Pat. No. 1,279,951 Wetzel
U.S. Pat. No. 1,333,470 Curran
U.S. Pat. No. 1,499,222 Kiley
U.S. Pat. No. 1,50,135 Morgan
U.S. Pat. No. 1,543,228 Morrow
U.S. Pat. No. 1,629,402 March
U.S. Pat. No. 1,762,668 Reichenau et al.
U.S. Pat. No. 1,823,365 Kozlowski
U.S. Pat. No. 1,867,252 Crigler
U.S. Pat. No. 1,900,199 Pickett
U.S. Pat. No. 1,936,644 Schroder
U.S. Pat. No. 1,974,549 A Spencer et al
U.S. Pat. No. 2,000,193 Schroder
U.S. Pat. No. 2,046,430 Rutherford
U.S. Pat. No. 2,137,582 Novak
U.S. Pat. No. 2,190,251 Brant
U.S. Pat. No. 2,552,997 Nelson
U.S. Pat. No. 2,715,295 Brown
U.S. Pat. No. 2,429,377 Stevens
U.S. Pat. No. 2,786,298 Smith
U.S. Pat. No. 3,340,646 Jadick
U.S. Pat. No. 3,505,757 Hall
U.S. Pat. No. 3,581,429 Hickman, et al.
U.S. Pat. No. 3,807,081 Chapiewsky
U.S. Pat. No. 3,908,302 Carr,
U.S. Pat. No. 3,997,999 Evans
U.S. Pat. No. 4,044,494 Grajnert
U.S. Pat. No. 4,244,135 Harwoods
U.S. Pat. No. 4,328,636 Johnson
U.S. Pat. No. 4,443,964 Horn, et al.
U.S. Pat. No. 4,501,088 Boisvert, et al.
U.S. Pat. No. 4,551,941 Schneidmiller
U.S. Pat. No. 4,794,724 Peters
U.S. Pat. No. 4,930,251 Crisanti
U.S. Pat. No. 5,081,788 Dowd et al,
U.S. Pat. No. 5,123,201 Reiter
U.S. Pat. No. 5,239,771 Beardsley
U.S. Pat. No. 5,309,668 Barton
U.S. Pat. No. 5,392,560 Donahue, et al.
U.S. Pat. No. 5,522,171 Mandeville
U.S. Pat. No. 5,685,109 Rimback
U.S. Pat. No. 5,987,809 Cheok
U.S. Pat. No. 5,987,810 Nash
U.S. Pat. No. 6,158,165 Wilson
U.S. Pat. No. 6,389,740 Perich, et al.
U.S. Pat. No. 6,718.687 Robinson
U.S. Pat. No. 6,990,768 Boston
U.S. Pat. No. 7,082,712 Harris et al.
U.S. Pat. No. 7,222,453 Uhl
U.S. Pat. No. 7,380,369 Greene et al.
U.S. Pat. No. 7,434,351 Bette
U.S. Pat. No. 7,472,511 Ng
U.S. Pat. No. 7,503,142 UhI to
U.S. Pat. No. 7,694,455 Bowden et al.
U.S. Pat. No. 7,886,481 Schneidmiller et al.
U.S. Pat. No. 7,946,077 Fukuhara
U.S. Pat. No. 8,205,378 Banfield
U.S. Pat. No. 8,677,678 Schneidmiller et al.
U.S. Pat. No. 8,959,830 McGavin
U.S. Pat. No. 9,237,741 Barrera, et al.
U.S. Pat. No. 9,433,202 Roberts
U.S. Pat. No. 9,554,567 Koehler et al.
20120110892 A1 LLOYD et al.
US 20130067795 A1 Wesson et al.
WO 2012047082 A1 Nieves
WO 201 21 641 32 A1 Ramoneda et al.
WO 2017019671 A1 Liang
WO 2009079041 A1 Schneidmiller et al.
WO 2004034783 A2 Eiras
WO 2008073121 A2 Ng and U.S. Pat. No. 7,472,511 Ng
US 20090071060 A1 McKay
US 20150289496 A1 Aroniss
US 20110078941 A1 Mathena
U.S. Pat. No. D478647 McNaughton

### OTHER PUBLICATIONS

https://parasitesandvectors.biomedcentral.com/articles/10.1186/s13071-017-2322-2
3D mosquito screens to create window double screen traps for mosquito control

### Authors, Ayman Khattab et al.

### Parasites & Vectors 201710:400

https://doi.org/10.1186/s13071-017-2322-2

### © The Author(s). 2017

### Published: 29 Aug. 2017

* DeVolpi disclosed in or around 2003 in a provisional patent 60/523,507 as well as old website in 2004 and to Gates foundation for funding and on the internet, can be seen http://Ia-ventana.forumotion.com/t1-cover-septic-systems-with-a-screen as shown again 2009. This is not a non-intuitive feature. 100% of mosquitos escape from this configuration concept that was tested in 2016. It was a failure.

None of the prior art insect traps include means with an intuitive entranceway, a ramp, and a non-intuitive exitway in the same entranceway. Many require sticky or poisons to be effective, where this invention does not. Many devices are not optimized for mosquitos that are more delicate and less aggressive than a fly in its search for entry as well as behavior.

This application claims priority to U.S. Provisional Application Ser. No. 62/396,218 filed on Sep. 18, 2016 and entitled “ONE WAY Mosquito trap”, the disclosure of which is incorporated herein by reference.

What is claimed is:

1. A flying mosquito trap comprising:
A trapping vessel that has at least one extended entryway element.
The extended entryway element that is intuitive for entry with a landing area of proper size to allow flying insect to enter with wings in motion. A non-obstructed entryway ramp within extended entryway element, fully contained within the extended entryway element that on opposing side has a reduced size exit-way with a non-intuitive feature to prevent re-entry pathway into reduced sized exit-way to entryway with an appropriately sized intuitive landing area opposed to the backside of the non-obstructed ramp.

2. The device of claim 1, wherein the said non-intuitive feature is a dead end ramp.

3. The device of claim 1, wherein the said non-intuitive feature is a non-linear density ramp.

4. The device of claim 1, wherein the said non-intuitive feature is a non-planer ramp aligned re-entry to entryway.

5. The device of claim 1, wherein the said non-intuitive feature way is an inverse cupping device ramp at the reduced sized exit-way.

7. The device of claim 1, wherein the said extended entryway element is breathable material allowing for adequate airflow and/or light transmission.

8. The device of claim 1, wherein the said vessel has at least one chamber separated by a physical barrier.

9. The device of claim 8, wherein at least one said physical barrier is air or light permeable.

10. The device of claim 1, wherein the said trapping vessel has a means to increase airflow.

11. The device of claim 1, wherein the said trapping vessel has a lure within.

12. The device of claim 1, wherein the said trapping vessel has a clean out means.

13. The device of claim 1, wherein the said trapping vessel is bounded with opposing screened sides that are perpendicular to said extended entryway element.

14. The device of claim 1, wherein the said trapping vessel is bounded with opposing screened sides that are perpendicular to more than one said extended entryway element.

15. The extended entryway element that is intuitive for entry with a landing area of proper size to allow flying insect to enter with wings in motion. With a non-obstructed ramp within extended entryway element, fully contained within the extended entryway element that on opposing side has a reduced size exit-way with a non-intuitive feature to prevent re-entry pathway into reduced sized exit-way to entryway with an appropriately sized intuitive landing area opposed to the backside of the non-obstructed ramp. A means for attaching same to containers.

16. The device of claim 15, wherein the said non-intuitive feature is a dead end ramp.

17. The device of claim 15, wherein the said non-intuitive feature is a non-linear density ramp.

18. The device of claim 15, wherein the said non-intuitive feature is a non-planer aligned re-entry to entryway.

19. The device of claim 15, wherein the said non-intuitive feature way is an inverse cupping device at the reduced sized exit-way.

20. The device of claim 15, wherein the said extended entryway element is breathable material allowing for adequate airflow and/or light transmission.
